(19) United States
(12) Patent Application Publication
(10) Pub. No.: US 2023/0403490 A1
(43) Pub. Date: Dec. 14, 2023

(54) Silicon-Based Microphone Apparatus And Electronic Device

(71) Applicant: GMEMS Tech Shenzhen Limited, Shenzhen Guangdong (CN)

(72) Inventors: Yunlong Wang, Shenzhen Guangdong (CN); Guanghua Wu, Shenzhen Guangdong (CN); Xingshuo Lan, Shenzhen Guangdong (CN)

(73) Assignee: GMEMS Tech Shenzhen Limited, Shenzhen Guangdong (CN)

(21) Appl. No.: 18/026,360

(22) PCT Filed: Feb. 7, 2021
(86) PCT No.: PCT/CN2021/075873

§ 371 Date: Mar. 15, 2023

(30) Foreign Application Priority Data
Sep. 17, 2020 (CN) 202010982978.8

(51) Int. Cl. H04R 1/08

(52) U.S. Cl. CPC H04R 1/083

(57) ABSTRACT

Embodiments of the present application provide a silicon-based microphone apparatus and an electronic device. The silicon-based microphone apparatus comprises: a circuit board provided with at least two sound inlet holes; a shielding cover covering one side of the circuit board to form an acoustic cavity; at least two silicon-based microphone chips both provided on one side of the circuit board and located in the acoustic cavity, back cavities of the silicon-based microphone chips being communicated with the sound inlet holes in one-to-one correspondence; and a differential control chip, microphone structures of all the silicon-based microphone chips being sequentially electrically connected and then being electrically connected to an input end of the differential control chip. In the embodiments of the present application, sound pickup structures of the at least two silicon-based microphone chips are used, and the back cavities of the silicon-based microphone chips are communicated with the sound inlet holes in one-to-one correspondence, such that acoustic waves all act on the silicon-based microphone chips to implement multi-collection of acoustic waves from one sound source or separate collection of acoustic waves from different sound sources; and then the differential control chip is used to further perform differential processing on mixed electric signals, thereby implementing noise reduction.

### CROSS-REFERENCE TO RELATED APPLICATION

This application claims priority to Application No. 2020109829788, filed on Sep. 17, 2020 in the China National Intellectual Property Administration (CNIPA), the disclosure of which is herein incorporated by reference in its entirety.

### TECHNICAL FIELD

The present disclosure relates to a technical field of acoustic-electrical conversion, and in particular, the present disclosure relates to a silicon-based microphone apparatus and an electronic device.

### BACKGROUND

When an existing silicon-based microphone acquires a sound signal, a silicon-based microphone chip in the microphone generates a vibration due to a sound wave acquired therefrom, and the vibration brings about a variation in capacitance that may form an electrical signal, thereby converting the sound wave into an electrical signal to be output. However, the noise processing of the existing microphone may not be ideal, affecting the quality of the output audio signal.

### SUMMARY

In view of the shortcomings of the existing method, a silicon-based microphone apparatus and an electronic device are proposed to solve the technical problem that the existing microphone has unsatisfactory noise processing and the quality of the output audio signal is affected in the prior art.

In a first aspect, an embodiment of the present disclosure provides a silicon-based microphone apparatus including: a circuit board provided with at least two sound inlet holes; a shielding housing covering one side of the circuit board to form a sound cavity; at least two silicon-based microphone chips disposed at the one side of the circuit board and located in the sound cavity, each of the at least two silicon-based microphone chips having a back cavity communicated with a respective one of the sound inlet holes; a differential control chip having an input terminal, wherein microphone structures of all the silicon-based microphone chips are sequentially electrically connected and then electrically connected to the input terminal.

In a second aspect, an embodiment of the present disclosure provides an electronic device including the silicon-based microphone apparatus described in the first aspect.

The technical solution provided by the embodiments of the present disclosure has the following beneficial technical effects. The silicon-based microphone apparatus adopts a pickup structure of at least two silicon-based microphone chips, and the back cavity of each silicon-based microphone chip is communicated with the respective sound inlet hole in a one-to-one correspondence, such that sound waves from the same source may act on each silicon-based microphone chip, or sound waves from different sources may act on the corresponding silicon-based microphone chip. That is, multiple acquisition of the sound waves from the same source or separate acquisition of the sound waves from different sources may be realized, and then the mixed electrical signal may be further differentially processed by the differential control chip to achieve noise reduction and improve the quality of the output audio signal.

Additional aspects and advantages of the present disclosure will be set forth partially in the following description, and would be apparent from the following description, or learned by practice of the present disclosure.

### BRIEF DESCRIPTION OF DRAWINGS

The above and/or additional aspects and advantages of the present disclosure will become apparent and readily understood from the following description of embodiments, taken in conjunction with the accompanying drawings, in which:

FIG. 1 is a schematic structural diagram of a silicon-based microphone apparatus according to an embodiment of the present disclosure;

FIG. 2 is a schematic structural diagram of a silicon-based microphone chip in a silicon-based microphone apparatus according to an embodiment of the present disclosure;

FIG. 3 is a schematic structural diagram of an electrical connection between two silicon-based microphone chips in a silicon-based microphone apparatus according to an embodiment of the present disclosure; and

FIG. 4 is a schematic structural diagram of another silicon-based microphone apparatus according to an embodiment of the present disclosure.

### IN DRAWINGS

100: circuit board; 110a: first sound inlet hole; 110b: second sound inlet hole;
200: shielding housing; 210: sound cavity;
300: silicon-based microphone chip; 300a: first silicon-based microphone chip; 300b: second silicon-based microphone chip;
301: microphone structure; 301a: microphone structure of first silicon-based microphone chip; 301b: microphone structure of second silicon-based microphone chip;
302: back cavity; 302a: back cavity of first silicon-based microphone chip; 302b: back cavity of second silicon-based microphone chip;
310: back plate; 310a: first back plate; 310b: second back plate;
311: airflow hole;
312: back plate electrode; 312a: back plate electrode of first back plate; 312b: back plate electrode of second back plate;
313: air gap;
320: semiconductor diaphragm; 320a: first semiconductor diaphragm; 320b: second semiconductor diaphragm;
321: semiconductor diaphragm electrode; 321a: semiconductor diaphragm electrode of first semiconductor diaphragm; 321b: semiconductor diaphragm electrode of second semiconductor diaphragm;
330: silicon substrate; 330a: first silicon substrate; 330b: second silicon substrate;
331: via hole;
340: first insulating layer;
350: second insulating layer;
360: wire;
400: differential control chip; and
500: separation member.

### DETAILED DESCRIPTION OF EMBODIMENTS

The present disclosure is described in detail below, and examples of embodiments of the present disclosure are illustrated in the accompanying drawings, in which the same or similar reference numerals throughout refer to the same or similar components, or components having the same or similar functions. Also, detailed description of the well-known technologies is omitted if it is not necessary for illustrating features of the present disclosure. The embodiments described below with reference to the accompanying drawings are exemplary and are only used to explain the present disclosure, but not to be construed to be limiting thereof.

It is to be understood by those skilled in the art that all terms (including technical and scientific terms) used herein have the same meaning as commonly understood by one of ordinary skill in the art to which the present disclosure belongs unless otherwise defined. It is further to be understood that terms, such as those defined in a general dictionary, should be understood to have meanings consistent with meanings thereof in the context of the prior art, and should not be interpreted in an idealistic or overly formal meaning unless specifically defined as herein.

It is to be understood by those skilled in the art that singular forms “a”, “an”, and “the” used herein may also include plural forms unless expressly stated. It is to be further understood that the word “includes”, “including”, “comprises” or “comprising” used in the specification of the present disclosure refers to presence of the stated feature, integer, element and/or component, but does not exclude presence or addition of one or more other features, integers, elements, components and/or a combination thereof. It is to be understood that when an element is referred to as being “connected” or “coupled” to another element, it may be directly connected or coupled to the other element or intervening elements may also be present. Further, the “connect” or “couple” as used herein may include wireless connection or wireless coupling. As used herein, the term “and/or” includes all or any one and all combination of one or more of the associated listed items.

On the basis of research, inventors of the present disclosure found that, with the popularization of IOT (The Internet of Things) devices such as smart speakers, it is not easy for a user to use a voice command on a smart device that is issuing a sound, for example, to issue a voice command such as an interrupt command or an wake-up command, etc. to a smart speaker that is playing music, or to communicate by using a hands-free operation of a mobile phone. The user often needs to interrupt the playing music with a special wake-up word when getting as close to the IOT device as possible, and then perform human-computer interaction. In these typical voice interaction scenarios, since the IOT device is in use, it is playing music or making sound through the speaker, thereby causing the vibration of the body, and such vibration is picked up by the microphone on the IOT device, such that an effect of echo cancellation is not excellent. This phenomenon is particularly significant in smart home products which generate a louder internal noise, such as a mobile phone playing music, a TWS (True Wireless Stereo) headphone, a robot vacuum, a smart air conditioner, a smart kitchen ventilator and the like.

The silicon-based microphone apparatus and electronic device provided by the present disclosure are intended to solve the above technical problems in the prior art.

The technical solutions of the present disclosure and how to solve the above-mentioned technical problems by using the same are described in detail below with reference to detailed embodiments.

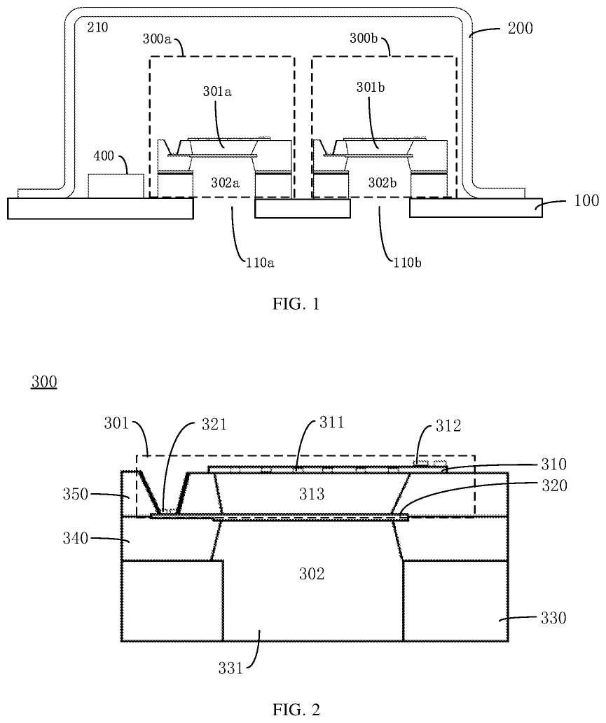

An embodiment of the present disclosure provides a silicon-based microphone apparatus, and the schematic structural diagram of the silicon-based microphone apparatus is shown in FIG. 1. The silicon-based microphone apparatus includes a circuit board 100, a shielding housing 200, at least two silicon-based microphone chips 300 and a differential control chip 400.

The circuit board 100 is provided with at least two sound inlet holes.

The shielding housing 200 covers one side of the circuit board 100 to form a sound cavity 210.

The at least two silicon-based microphone chips 300 are disposed at the one side of the circuit board 100 and are located in the sound cavity 210. Each of the at least two silicon-based microphone chips 300 has a back cavity 302 communicated with a respective one of the sound inlet holes.

Microphone structures 301 of all the silicon-based microphone chips 300 are sequentially electrically connected and then electrically connected to an input terminal of the differential control chip 400.

In the present embodiment, the silicon-based microphone apparatus employs a pickup structure of at least two silicon-based microphone chips 300. It is to be noted that the silicon-based microphone apparatus in FIG. 1 is only exemplified as having two silicon-based microphone chips 300.

The silicon-based microphone apparatus adopts a pickup structure of at least two silicon-based microphone chips 300, and the back cavity 302 of each silicon-based microphone chip 300 is communicated with the respective sound inlet hole (that is, a first sound inlet hole 110a and a second sound inlet hole 110b) in a one-to-one correspondence, such that sound waves from the same source may act on each silicon-based microphone chip 300, or sound waves from different sources may act on the corresponding silicon-based microphone chip 300. That is, multiple acquisition of the sound waves from the same source or separate acquisition of the sound waves from different sources may be realized, and the mixed electrical signal (including a sound electrical signal and a noise electrical signal) may be further differentially processed by the differential control chip 400 to achieve noise reduction and improve the quality of the output audio signal.

Optionally, the silicon-based microphone chips 300 are fixedly attached to the circuit board 100 through silica gel.

A relatively closed sound cavity 210 is enclosed between the shielding housing 200 and the circuit board 100. In order to shield the devices such as silicon-based microphone chips 300 in the sound cavity 210 from suffering the electromagnetic interference, the shielding housing 200 may optionally include a metal housing, and the metal housing is electrically connected with the circuit board 100.

Optionally, the shielding housing 200 may be fixedly attached to the one side of the circuit board 100 through solder paste or conductive glue.

Optionally, the circuit board 100 may include a PCB (printed circuit board).

In some possible embodiments, as shown in FIG. 2, the silicon-based microphone chip 300 according to an embodiment of the present disclosure may include a back plate 310 and a semiconductor diaphragm 320 disposed to be stacked and spaced apart from each other.

The back plate 310 and the semiconductor diaphragm 320 constitute a main body of the microphone structure 301.

The back plate 310 has a portion provided with a plurality of air flow holes 311 corresponding to the sound inlet hole.

In the present embodiment, the back plate 310 and the semiconductor diaphragm 320 constitute a main body of the microphone structure 301. A gap, such as an air gap 313, may be provided between the back plate 310 and the semiconductor diaphragm 320. The semiconductor diaphragm 320 may be implemented with a thinner structure with stronger toughness, and may be deformed and bent under the action of the sound wave. The back plate 310 may be implemented with a structure having a thickness much larger than that of the semiconductor diaphragm 320 and a stronger rigidity, which is not easily deformed.

Specifically, the semiconductor diaphragm 320 and the back plate 310 may be arranged in parallel and separated by the air gap 313, thereby forming the main body of the microphone structure 301. It could be understood that an electric field (non-conduction) may be formed between the semiconductor diaphragm 320 and the back plate 310. The sound wave entering through the sound inlet hole may contact the semiconductor diaphragm 320 after passing through the back cavity 302.

When the sound wave enters the back cavity 302 of the silicon-based microphone chip 300, the semiconductor diaphragm 320 may be deformed under the action of the sound wave. The deformation may cause the gap between the semiconductor diaphragm 320 and the back plate 310 to be changed, which may bring about variation in capacitance between the semiconductor diaphragm 320 and the back plate 310, such that the conversion of the sound wave into the electrical signal is realized.

For a single silicon-based microphone chip 300, by applying a bias voltage between the semiconductor diaphragm 320 and the back plate 310, an electric field may be formed in the gap between the semiconductor diaphragm 320 and the back plate 310.

Optionally, the semiconductor diaphragm 320 may be made of a polysilicon material, and the semiconductor diaphragm 320 has a thickness of no greater than 1 micrometer, thus the semiconductor diaphragm 320 may be deformed even under an action of a relatively weak sound wave, and the sensitivity is relatively high. The back plate 310 may be made of a material with relatively stronger rigidity and having a thickness of several micrometers. A plurality of airflow holes 311 are formed on the back plate 310 by etching. Therefore, when the semiconductor diaphragm 320 is deformed by the action of the sound wave, the back plate 310 may not be affected to generate deformation.

Optionally, the gap between the semiconductor diaphragm 320 and the back plate 310 has a size of several micrometers, that is, in the order of micrometers.

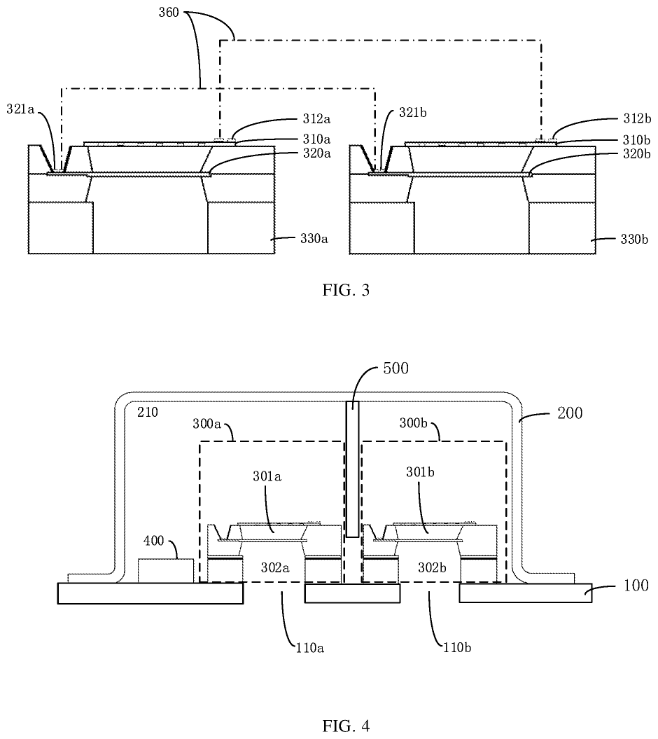

In some possible embodiments, as shown in FIG. 3, every two of the silicon-based microphone chips 300 include a first silicon-based microphone chip 300a and a second silicon-based microphone chip 300b.

A first back plate 310a of the first silicon-based microphone chip 300a is electrically connected with a second back plate 310b of the second silicon-based microphone chip 300b to form a superposed signal.

In the present embodiment, by superimposing a mixed electrical signal generated at the back plate 310a of the first silicon-based microphone chip 300a and a mixed electrical signal generated at the second back plate 310b of the second silicon-based microphone chip 300b to form a first signal, the homologous noise signal from the mixed electrical signal may be attenuated or counteracted, thus the quality of the first signal may be improved.

Specifically, a back plate electrode 312a of the first back plate may be electrically connected with a back plate electrode 312b of the second back plate through a wire 360 to form a path of the first signal.

In some possible embodiments, as shown in FIG. 3, the first semiconductor diaphragm 320a of the first silicon-based microphone chip 300a is electrically connected with the second semiconductor diaphragm 320b of the second silicon-based microphone chip 300b, and at least one of the first semiconductor diaphragm 320a and the second semiconductor diaphragm 320b is electrically connected with a constant voltage source.

In the present embodiment, the first semiconductor diaphragm 320a of the first silicon-based microphone chip 300a is electrically connected with the second semiconductor diaphragm 320b of the second silicon-based microphone chip 300b, such that the semiconductor diaphragms 320 of the two differential silicon-based microphone chips 300 may have the same potential. That is, the criterion that the two differential silicon-based microphone chips 300 generate electrical signals may be unified.

Specifically, the wire 360 may be respectively electrically connected with the semiconductor diaphragm electrode 321a of the first semiconductor diaphragm and the semiconductor diaphragm electrode 321b of the second semiconductor diaphragm.

Optionally, the semiconductor diaphragms 320 of all the silicon-based microphone chips 300 may be electrically connected, such that the criterion that the silicon-based microphone chips 300 generate electrical signals may be unified.

In some possible embodiments, as shown in FIG. 1, the differential control chip 400 according to an embodiment of the present disclosure is located in the sound cavity 210 and electrically connected with the circuit board 100.

One of the first back plate 310a and the second back plate 310b is electrically connected with one signal input terminal of the differential control chip 400.

In the present embodiment, the differential control chip 400 may receive the superimposed mixed electrical signal output by the silicon-based microphone chips 300 described as above, and perform differential processing. For example, by using the fact that the increment of the superimposed sound electrical signal is greater than the increment of the noise electrical signal, noise removal may be achieved. The common mode noise may be reduced, and the signal-to-noise ratio and the sound pressure overload point may be improved, thereby improving the sound quality.

Optionally, the differential control chip 400 is fixedly attached to the circuit board 100 through silica gel or red glue.

Optionally, the differential control chip 400 includes an application specific integrated circuit (ASIC) chip having differential function.

In some possible embodiments, as shown in FIG. 2, the silicon-based microphone chip 300 includes a silicon substrate 330.

The microphone structure 301 is disposed at one side of the silicon substrate 330.

The silicon substrate 330 has a via hole 331 for forming the back cavity 302, and the via hole 331 corresponds to the microphone structure 301. A side of the silicon substrate 330 away from the microphone structure 301 is fixedly attached to the circuit board 100. The via hole 331 is communicated with the sound inlet hole.

In the present embodiment, the silicon substrate 330 supports the microphone structure 301. The via hole 331 for forming the back cavity 302 in the silicon substrate 330 may facilitate the entry of the sound waves into the silicon-based microphone chip 300. The sound waves may act on the microphone structure 301, such that the microphone structure 301 generates the mixed electrical signal.

In some possible embodiments, as shown in FIG. 2, the silicon-based microphone chip 300 further includes a patterned first insulating layer 340 and a patterned second insulating layer 350.

The silicon substrate 330, the first insulating layer 340, the semiconductor diaphragm 320, the second insulating layer 350 and the back plate 310 are disposed to be stacked sequentially.

In the present embodiment, the semiconductor diaphragm 320 and the silicon substrate 330 are separated from each other by the patterned first insulating layer 340, and the semiconductor diaphragm 320 and the back plate 310 are separated from each other by the patterned second insulating layer 350, such that an electrical separation is formed between the conductive layers, and a short circuit between the conductive layers may be avoided, and thus reduction of the signal accuracy may be avoided.

Optionally, each of the first insulating layer 340 and the second insulating layer 350 may be formed by forming an integrated film and then patterning the integrated film by an etching process to remove a portion of the integrated film corresponding to an area of the via hole 331 and an area for preparing an electrode.

On the basis of research, inventors of the present disclosure further found that, when a silicon-based microphone device having multiple microphone chips is used, noise reduction may be effectively realized. At the same time, inventors of the present disclosure noted that, if the sound energies received by the multiple microphone chips are inconsistent, the sound wave having higher energy may continue to propagate in the sound cavity 210 of the silicon-based microphone apparatus, causing interference to other microphone chips (the smaller the volume of the sound cavity 210, the more obvious the interference), which will reduce the pickup accuracy of other microphone chips, and thus affect the quality of the audio signal output by the silicon-based microphone apparatus.

To this end, the present disclosure provides the following possible implementation for the electrical connection of each silicon-based microphone chip 300.

As shown in FIG. 4, the silicon-based microphone apparatus according to an embodiment of the present disclosure further includes a separation member 500.

The separation member 500 is located in the sound cavity 210 and separates the sound cavity 210 into sub-sound cavities 210 corresponding to the back cavities 302 of at least portion of the silicon-based microphone chips 300 adjacent thereto.

In the present embodiment, the separation member 500 separates the sound cavity 210 into sub-sound cavities 210 corresponding to the back cavities 302 of at least portion of the silicon-based microphone chips 300 adjacent thereto, which may effectively reduce the probability or intensity of sound waves entering the back cavity 302 of each silicon-based microphone chip 300 to continue to propagate in the sound cavity 210 of the silicon-based microphone apparatus, reduce the interference of the sound waves to other silicon-based microphone chips 300, and effectively improve the pickup accuracy of each silicon-based microphone chip 300, thereby improving the quality of audio signals output by the silicon-based microphone apparatus.

Optionally, the separation member 500 may adopt a structure having a single plate shape, a cylinder structure or a honeycomb structure.

In some possible embodiments, as shown in FIG. 4, the separation member 500 according to an embodiment of the present disclosure has one end extending toward the shielding housing 200 and the other end extending at least to a side of the silicon-based microphone chip 300 away from the circuit board 100.

In the present embodiment, one end of the separation member 500 extends toward the shielding housing 200, and the other end thereof extends at least to a side of the silicon-based microphone chip 300 away from the circuit board 100. In this way, the sub-sound cavities 210 having a certain degree of enclosure may be formed with the help of the structure of the shielding housing 200 and the silicon-based microphone chip 300 together with the separation member 500, that is, the sound wave passing through the back cavity 302 of the silicon-based microphone chip 300 may be surrounded to a certain extent, thus the probability or intensity of the incoming sound waves continuing to propagate in the sound cavity 210 of the silicon-based microphone apparatus may be reduced, the interference of the sound waves to other silicon-based microphone chips 300 may be reduced, the pickup accuracy of each silicon-based microphone chip 300 may be effectively improved, thereby improving the quality of audio signals output by the silicon-based microphone apparatus.

Optionally, as shown in FIG. 4, the separation member 500 according to an embodiment of the present disclosure has one end attached to the shielding housing 200. That is, the sides close to the shield housing 200 of the adjacent sub-sound cavities 210 separated by the separation member 500 are completely separated, which strengthens the separation between adjacent sub-sound cavities 210, further reduces the interference of the sound waves to other silicon-based microphone chips 300, and effectively improves the pickup accuracy of each silicon-based microphone chip 300, thereby improving the quality of audio signals output by the silicon-based microphone apparatus.

Optionally, the separation member 500 according to an embodiment of the present disclosure has the other end attached to one side of the circuit board 100. That is, the sides close to the circuit board 100 of the adjacent sub-sound cavities 210 separated by the separation member 500 are completely separated, which strengthens the separation between adjacent sub-sound cavities 210, further reduces the interference of the sound waves to other silicon-based microphone chips 300, and effectively improves the pickup accuracy of each silicon-based microphone chip 300, thereby improving the quality of audio signals output by the silicon-based microphone apparatus.

Based on the same inventive concept, an embodiment of the present disclosure further provides an electronic device including the silicon-based microphone apparatus described in any one of the described embodiments as above.

In the present embodiment, the electronic device may be a smart home product with large vibration such as a mobile phone, a TWS (True Wireless Stereo) headset, a robot vacuum cleaner, a smart air conditioner, a smart kitchen ventilator and the like. Since each of the electronic devices adopts the silicon-based microphone apparatus described in the foregoing embodiments, the principles and technical effects thereof may refer to the foregoing embodiments, and will not be repeated herein.

In some embodiments of the present disclosure, the silicon-based microphone apparatus adopts a pickup structure of at least two silicon-based microphone chips 300, and the back cavity 302 of each silicon-based microphone chip 300 is communicated with the respective sound inlet hole (that is, a first sound inlet hole 110a and a second sound inlet hole 110b) in a one-to-one correspondence, such that sound waves from the same source may act on each silicon-based microphone chip 300, or sound waves from different sources may act on the corresponding silicon-based microphone chip 300. That is, multiple acquisition of the sound waves from the same source or separate acquisition of the sound waves from different sources may be realized, and the mixed electrical signal (including a sound electrical signal and a noise electrical signal) may be further differentially processed by the differential control chip 400 to achieve noise reduction and improve the quality of the output audio signal.

In some embodiments of the present disclosure, the silicon-based microphone chip 300 includes a back plate 310 and a semiconductor diaphragm 320 disposed to be stacked and spaced apart from each other, that is, a pickup structure of a single back plate 310 and a semiconductor diaphragm 320 is adopted. When the sound wave enters the back cavity 302 of the silicon-based microphone chip 300, the semiconductor diaphragm 320 may be deformed under the action of the sound wave. The deformation may cause the gap between the semiconductor diaphragm 320 and the back plate 310 to be changed, which may bring about variation in capacitance between the semiconductor diaphragm 320 and the back plate 310, such that the conversion of the sound wave into the electrical signal is realized.

In some embodiments of the present disclosure, the separation member 500 separates the sound cavity 210 into sub-sound cavities 210 corresponding to the back cavities 302 of at least portion of the silicon-based microphone chips 300 adjacent thereto, which may effectively reduce the probability or intensity of sound waves entering the back cavity 302 of each silicon-based microphone chip 300 to continue to propagate in the sound cavity 210 of the silicon-based microphone apparatus, reduce the interference of the sound waves to other silicon-based microphone chips 300, and effectively improve the pickup accuracy of each silicon-based microphone chip 300, thereby improving the quality of audio signals output by the silicon-based microphone apparatus.

In the description of the present disclosure, it is to be understood that orientations or positional relationships indicated by the terms “center”, “upper”, “lower”, “front”, “rear”, “left”, “right”, “vertical”, “horizontal”, “top”, “bottom”, “inside”, “outside” and so on are based on the orientations or positional relationships shown in the accompanying drawings, which are only for convenience of describing the present disclosure and simplifying the description, rather than indicating or implying that the device or element referred necessarily has a particular orientation, needs to be constructed and operated in a particular orientation, and therefore, those terms should not be construed as a limitation to the present disclosure.

The terms “first” and “second” are used for describing purposes only, and should not be understood as indicating or implying relative importance or implying the number of technical features indicated. Thus, a feature defined by “first” or “second” may expressly or implicitly include one or more of such features. In the description of the present disclosure, unless stated otherwise, “plurality of” means two or more than two.

In the description of the present disclosure, it is to be noted that, unless otherwise expressly specified and limited, the terms “installed”, “connected” and “connection” should be understood in a broader sense, for example, a connection may be a fixed connection or a removable connection, or an integral connection; a connection may be directly connection, or indirectly connection through an intermediate medium, or may be an internal communication of two elements. The specific meanings of the above terms in the present disclosure may be understood by those ordinary skilled in the art according to specific situations.

In the description of the present specification, the particular features, structures, materials or characteristics may be combined in any suitable manner in any one or more of the embodiments or examples.

The above description is only some embodiments of the present disclosure, it is to be noted that, some improvements and modifications may also be made by those ordinary skilled in the art without departing from the principle of the present disclosure. These improvements and modifications should also be considered to be within the scope of the present disclosure.

1. A silicon-based microphone apparatus, comprising:
a circuit board provided with at least two sound inlet holes;
a shielding housing covering one side of the circuit board to form a sound cavity;
at least two silicon-based microphone chips disposed at the one side of the circuit board and located in the sound cavity, each of the at least two silicon-based microphone chips having a back cavity communicated with a respective one of the sound inlet holes; and
a differential control chip having an input terminal, wherein microphone structures of all the silicon-based microphone chips are sequentially electrically connected and then electrically connected to the input terminal.

2. The silicon-based microphone apparatus of claim 1, wherein each of the silicon-based microphone chips includes a back plate and a semiconductor diaphragm disposed to be stacked and spaced apart from each other;
the back plate and the semiconductor diaphragm constitute a main body of the microphone structure; and
the back plate has a portion provided with a plurality of airflow holes corresponding to the sound inlet hole.

3. The silicon-based microphone apparatus of claim 2, wherein every two of the at least two silicon-based microphone chips include a first silicon-based microphone chip and a second silicon-based microphone chip; and
a first back plate of the first silicon-based microphone chip is electrically connected with a second back plate of the second silicon-based microphone chip to form a superposed signal.

4. The silicon-based microphone apparatus of claim 3, wherein a first semiconductor diaphragm of the first silicon-based microphone chip is electrically connected with a second semiconductor diaphragm of the second silicon-based microphone chip, and at least one of the first semiconductor diaphragm and the second semiconductor diaphragm is electrically connected with a constant voltage source.

5. The silicon-based microphone apparatus of claim 3, wherein the differential control chip is located in the sound cavity and electrically connected with the circuit board; and
one of the first back plate and the second back plate is electrically connected with a signal input terminal of the differential control chip.

6. The silicon-based microphone apparatus of claim 1, further comprising a separation member located in the sound cavity and separating the sound cavity into sub-sound cavities corresponding to the back cavities of at least portion of the silicon-based microphone chips adjacent thereto.

7. The silicon-based microphone apparatus of claim 6, wherein the separation member has one end extending toward the shielding housing and the other end extending at least to a side of the silicon-based microphone chip away from the circuit board.

8. The silicon-based microphone apparatus of claim 7, wherein the one end of the separation member is attached to the shielding housing.

9. The silicon-based microphone apparatus of claim 8, wherein the other end of the separation member is attached to the one side of the circuit board.

10. An electronic device comprising the silicon-based microphone apparatus of claim 1.
